(19) United States
(12) Patent Application Publication
(10) Pub. No.: US 2026/0340492 A1
(43) Pub. Date: Oct. 29, 2026

(54) MACHINE LEARNING MODEL PERFORMANCE MONITORING AND ADJUSTMENT USING DYNAMIC MODEL-BASED PERFORMANCE CRITERIA

(71) Applicant: FMR LLC, Boston, MA (US)

(72) Inventors: Srija Chowdhury, Karnataka (IN); Vibha Rajan, Karnataka (IN)

(21) Appl. No.: 19/191,118

(22) Filed: Apr. 28, 2025

(51) Int. Cl. G06N 20/00

(52) U.S. Cl. CPC G06N 20/00

(57) ABSTRACT

Methods and apparatuses for machine learning (ML) model performance monitoring and adjustment using dynamic model-based performance criteria include executing an ML model in monitoring runs over a first time period, generating a first subset of the performance data comprising data for each monitoring run that is outside of a static performance threshold range and a second subset of the performance data comprising data for the remaining monitoring runs, calculating a dynamic threshold based upon the second subset of data, setting a performance alert value when a difference between the performance metric and a baseline value exceeds the dynamic threshold, generating a performance anomaly alert based upon a number of monitoring runs in the first subset of data and a number of monitoring runs in the second subset of data that have an alert value set, and adjusting hyperparameters, the static performance threshold range, or a baseline job execution schedule.

### TECHNICAL FIELD

This application relates generally to methods and apparatuses, including computer program products, for machine learning (ML) model performance monitoring and adjustment using dynamic model-based performance criteria.

### BACKGROUND

Recently, advanced data analysis methodologies that rely on machine learning, such as machine learning (ML) classification models or regression models, have become widely available. As can be appreciated, deployment and execution of ML models typically requires significant computing resources (e.g., CPU, memory) and lengthy periods of iteration and refinement to accurately perform the functions for which they are designed. With unlimited computing resources and unlimited time, ML models can be designed to achieve highly accurate performance. In many production environments, however, computing resources and development time is limited due to overhead, availability, and cost. System administrators and model designers are required to implement performance constraints on classification models to satisfy any imposed limitations. This can impact the performance and accuracy of the resulting models—which makes choice of classification algorithms, hyperparameter tuning, and data processing techniques used to build the model even more important. In spite of these limitations, production classification models must still be able to generate results that are as accurate as possible in real-time or near real-time while also working under the designated performance constraints and restrictions.

In addition, most classification models are static, i.e., once they are deployed to a production environment, the algorithms they use and the analysis they perform does not change. In contrast, the data being provided to such classification models for analysis does change over time which can result in a decrease in accuracy from the classification model.

Model monitoring software platforms exist to track the performance of classification models over time and to generate alerts when the performance of the models diverges from acceptable performance thresholds. However, such platforms typically are unable to adjust to a specific classification model's performance as observed in production to dynamically adjust the number of alerts that are generated. In addition, these software platforms suffer from a significant dependency on inputs like strict performance thresholds provided by the model owner. As can be appreciated, these software platforms often produce redundant and repetitive alerts, which reduce the model owner's reliance on monitoring solutions and their level of attention to alerts. Therefore, when a critical performance alert is generated by these platforms, the model owner may overlook or even disregard the alert-leading to degradation of model performance and potential risk of downstream data errors for users who are accessing or consuming the model.

### SUMMARY

Therefore, what is needed are methods and systems that can capture and analyze performance metrics generated during ML model monitoring runs over a period of time to apply time-based, dynamic thresholds for identifying potentially anomalous model performance. The techniques described herein advantageously overcome the above-identified technical deficiencies of existing model monitoring platforms by:
1) Reducing the dependency on static performance thresholds which may be set by a model owner reviewing benchmark model performance metrics. Because the performance of an ML model can be quite different in production, such benchmarked threshold values do not generate relevant alerts.
2) Providing an intelligence layer that makes the generation of model performance alerts more useful and dynamic. The systems and methods beneficially reduce the occurrence of redundant alerts which enables model owners and stakeholders to focus their attention on performance-critical alerts.
3) Generating insights and reports to help model owners understand the observed performance of an ML model, which in turn enables the model owner to take an informed decision/necessary action regarding model retraining and/or decommissioning.

In addition, the techniques described herein provide the technical feature of identifying alert patterns across a plurality of modeling runs using time-series concepts in order to detect consistent anomalous performance of an ML model.

The invention, in one aspect, features a computer system for machine learning model performance monitoring and adjustment using dynamic model-based performance criteria. The system includes a server computing device having a memory that stores computer-executable instructions and a processor that executes the computer-executable instructions. The server computing device executes a machine learning model for a plurality of monitoring runs over a first time period to generate performance data comprising, for each of the plurality of monitoring runs, a performance metric associated with execution of the machine learning model for the monitoring run. The server computing device generates (i) a first subset of the performance data comprising the performance metrics for each monitoring run in the performance data that are outside of a static performance threshold range for the machine learning model and (ii) a second subset of the performance data comprising the performance metrics for the remaining monitoring runs. The server computing device calculates a dynamic performance threshold for the machine learning model based upon the second subset of performance data. The server computing device sets, for each monitoring run in the second subset of performance data, a performance alert value when a difference between the performance metric for the monitoring run and a baseline value exceeds the dynamic performance threshold for the machine learning model. The server computing device generates a performance anomaly alert for the machine learning model based upon one or more of: (i) a number of monitoring runs in the first subset of performance data and (ii) a number of monitoring runs in the second subset of performance data that have a performance alert value set. The server computing device adjusts (i) one or more hyperparameters associated with monitoring of the machine learning model, (ii) the static performance threshold range, or (iii) a baseline job execution schedule for the machine learning model, based upon the performance anomaly alert.

The invention, in another aspect, features a computerized method of machine learning model performance monitoring and adjustment using dynamic model-based performance criteria. A server computing device executes a machine learning model for a plurality of monitoring runs over a first time period to generate performance data comprising, for each of the plurality of monitoring runs, a performance metric associated with execution of the machine learning model for the monitoring run. The server computing device generates (i) a first subset of the performance data comprising the performance metrics for each monitoring run in the performance data that are outside of a static performance threshold range for the machine learning model and (ii) a second subset of the performance data comprising the performance metrics for the remaining monitoring runs. The server computing device calculates a dynamic performance threshold for the machine learning model based upon the second subset of performance data. The server computing device sets, for each monitoring run in the second subset of performance data, a performance alert value when a difference between the performance metric for the monitoring run and a baseline value exceeds the dynamic performance threshold for the machine learning model. The server computing device generates a performance anomaly alert for the machine learning model based upon one or more of: (i) a number of monitoring runs in the first subset of performance data and (ii) a number of monitoring runs in the second subset of performance data that have a performance alert value set. The server computing device adjusts (i) one or more hyperparameters associated with monitoring of the machine learning model, (ii) the static performance threshold range, or (iii) a baseline job execution schedule for the machine learning model, based upon the performance anomaly alert.

Any of the above aspects can include one or more of the following features. In some embodiments, the server computing device retrains the machine learning model based upon the adjustments. In some embodiments, the server computing device executes the retrained machine learning model for a second plurality of monitoring runs over a second time period to generate second performance data comprising, for each of the second plurality of monitoring runs, a second performance metric associated with execution of the machine learning model for the monitoring run.

In some embodiments, the performance metric for each of the plurality of monitoring runs comprises model accuracy, model recall, model precision, or combinations thereof. In some embodiments, the dynamic performance threshold for the machine learning model is calculated using the formula

dynamic performance threshold=mean(|d|)+α*σ(|d|)

where d is the difference between the performance metrics for each monitoring run in the second subset of performance data and the baseline value and α is a constant value. In some embodiments, α is in the range of 1.5 to 2. In some embodiments, adjusting one or more hyperparameters associated with monitoring of the machine learning model comprises updating a used in calculating the dynamic performance threshold.

In some embodiments, generating a performance anomaly alert for the machine learning model comprises detecting a pattern based on the number of monitoring runs in the first subset of performance data and the number of monitoring runs in the second subset of performance data that have a performance alert value set; and generating the performance anomaly alert for the machine learning model based on the detected pattern. In some embodiments, generating a performance anomaly alert for the machine learning model comprises removing one or more redundancies in the monitoring runs in the second subset of performance data that have a performance alert value set.

In some embodiments, the performance anomaly alert is transmitted to a remote computing device for display to a user and receipt of feedback from the user. In some embodiments, the server computing device provides a decommission recommendation for the machine learning model from a production computing environment based upon the performance anomaly alert.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for machine learning (ML) model performance monitoring and adjustment using dynamic model-based performance criteria.

FIG. 2 is a flow diagram of a computerized method of machine learning (ML) model performance monitoring and adjustment using dynamic model-based performance criteria.

FIG. 3 is a flow diagram of an exemplary computerized method for detecting a performance alert based upon performance data outside of a static threshold range.

FIG. 4 is a diagram of performance data, threshold data, and alert data for a plurality of monitoring runs of an ML model.

FIG. 5A is a flow diagram of an exemplary computerized method for detecting a dynamic threshold alert.

FIG. 5B is a flow diagram of an exemplary computerized method for calculating a dynamic threshold upper bound (UB) value.

FIG. 6 is a diagram of an exemplary computerized method of generating a performance anomaly alert for an ML model.

FIG. 7A is a diagram of an exemplary user interface of an alert summary report for a specific monitoring run.

FIG. 7B is a diagram of an exemplary user interface of an alert summary report for a plurality of monitoring runs in a given time period.

FIG. 8 is a diagram of an exemplary workflow for determining one or more changes to hyperparameters associated with monitoring of the model and/or the model static threshold range values based upon user feedback.

FIG. 9 is a diagram of an exemplary workflow for determining changes to model static threshold range values based upon user feedback.

### DETAILED DESCRIPTION

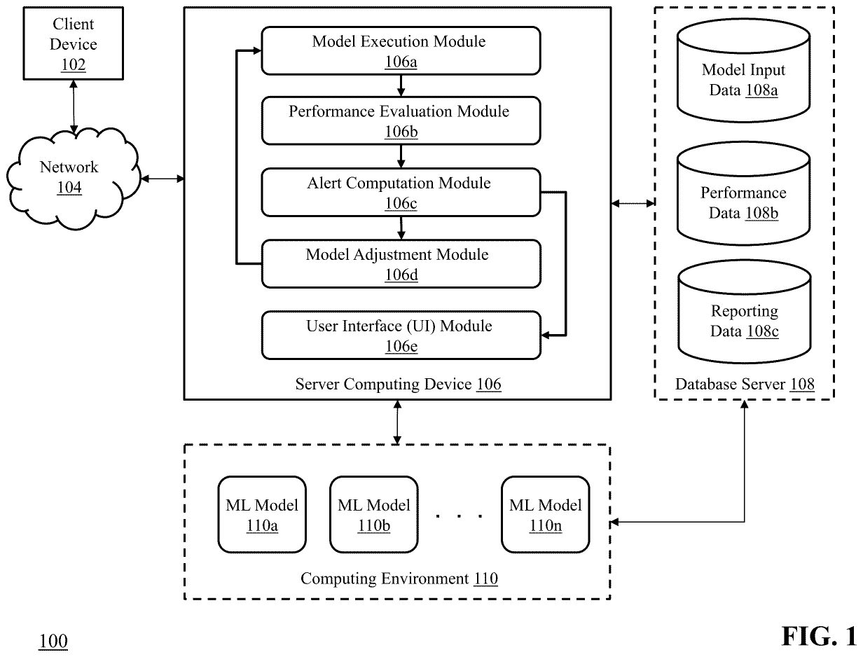

FIG. 1 is a block diagram of system 100 for machine learning (ML) model performance monitoring and adjustment using dynamic model-based performance criteria. System 100 includes client computing device 102, communication network 104, server computing device 106 with model execution module 106a, performance evaluation module 106b, alert computation module 106c, model adjustment module 106d, and user interface (UI) module 106e, database server 108 comprising model input data database 108a, performance data database 108b, and reporting data database 108c, and computing environment 110 including a plurality of ML models 110a-110n.

Client computing device 102 connects to communication network 104 in order to communicate with server computing device 106 to provide input and receive output relating to the process of ML model performance monitoring and adjustment using dynamic model-based performance criteria as described herein. In some embodiments, client computing device 102 is coupled to an associated display device (not shown). For example, client computing device 102 can provide a graphical user interface (GUI) via the display device that is configured to receive input from a user of the device 102 and to present output to the user that results from the methods and systems described herein.

Exemplary client computing devices 102 include but are not limited to desktop computers, laptop computers, tablets, mobile devices, smartphones, and internet appliances. It should be appreciated that other types of computing devices that are capable of connecting to the components of system 100 can be used without departing from the scope of invention. Although FIG. 1 depicts a single client computing device 102, it should be appreciated that system 100 can include any number of client computing devices.

Communication network 104 enables the client computing device 102 to communicate with server computing device 106. Network 104 is typically a wide area network, such as the Internet and/or a cellular network. In some embodiments, network 104 is comprised of several discrete networks and/or sub-networks (e.g., cellular to Internet).

Server computing device 106 is a device including specialized hardware and/or software modules that execute on one or more processors and interact with one or more memory modules of server computing device 106, to receive data from other components of system 100, transmit data to other components of system 100, and perform functions for ML model performance monitoring and adjustment using dynamic model-based performance criteria as described herein. As mentioned above, server computing device 106 includes model execution module 106a, performance evaluation module 106b, alert computation module 106c, model adjustment module 106d, and user interface (UI) module 106e which each execute on one or more processors of server computing device 106. In some embodiments, modules 106a-106e are specialized sets of computer software instructions programmed onto one or more dedicated processors in server computing device 106 and can include designated memory locations and/or registers for executing the specialized computer software instructions.

Although modules 106a-106e are shown in FIG. 1 as executing within the same server computing device 106, in some embodiments the functionality of modules 106a-106e can be distributed among a plurality of server computing devices. As shown in FIG. 1, server computing device 106 enables modules 106a-106e to communicate with each other in order to exchange data for the purpose of performing the described functions. It should be appreciated that any number of computing devices, arranged in a variety of architectures, resources, and configurations (e.g., cluster computing, virtual computing, cloud computing) can be used without departing from the scope of the invention. The exemplary functionality of modules 106a-106e is described in detail throughout the specification.

Database server 108 is a computing device (or set of computing devices) coupled to server computing device 106. Server 108 is configured to receive, generate, and store specific segments of data relating to the process of constraint-based optimization of machine learning classification models as described herein. Database server 108 comprises a plurality of databases 108a-108c, including model input data database 108a, performance data database 108b, and reporting data database 108c. In some embodiments, all or a portion of the databases 108a-108c can be integrated with server computing device 106 or be located on a separate computing device or devices. Databases 108a-108c can comprise one or more databases configured to store portions of data used by the other components of system 100, as will be described in greater detail below.

Computing environment 110 comprises one or more computing devices coupled to server computing device 106 and database server 108. Computing environment 110 hosts one or more machine learning models (i.e., models 110a-110n) that are configured according to model pipelines generated by server computing device 106. The ML models hosted in computing environment can receive input data from one or more external data sources and process the data to, e.g., generate output. Generally, a machine learning model is configured to perform one or more tasks, such as automated classification of input data into one or more groups or categories according to features of the input data. In some embodiments, ML models 110a-110n are classification models trained on existing datasets with known classification values/labels to generate predictions of classification values/labels for datasets that have not been labeled. An example label can be a binary value (e.g., 0 for or 1), an alphanumeric value, or other types of labeling mechanisms. Other computing systems can connect to computing environment 110 to provide input data to ML models 110a-110n, which classifies the input data and returns the classified data to the requesting system. The requesting system can analyze the classifications generated by ML models 110a-110n to, e.g., take further actions such as identifying data for priority analysis, providing content recommendations, and/or predicting future user activity-among other functions.

In some embodiments, computing environment 110 is a cloud-based environment with resources distributed into a plurality of regions defined according to certain geographic and/or technical performance requirements. Each region can comprise one or more datacenters connected via a regional network that meets specific low-latency requirements. Inside each region, computing environment 110 can be partitioned into one or more availability zones (AZs), which are physically separate locations used to achieve tolerance to, e.g., hardware failures, software failures, disruption in connectivity, unexpected events/disasters, and the like. Typically, the availability zones are connected using a high-performance network (e.g., round trip latency of less than two milliseconds). It should be appreciated that other types of computing resource distribution and configuration in a cloud environment can be used within the scope of the technology described herein. In some embodiments, computing environment 110 is a local computing environment (also called an ‘on-prem’ environment) comprising physical and/or virtual computing resources in a defined location. It should be appreciated that in some embodiments, production computing environment 110 comprises a hybrid on-prem and cloud-based computing environment.

In some embodiments, model execution module 106a is configured to periodically execute monitoring runs of one or more ML models 110a-110n in computing environment 110 over a defined time period to generate performance data for the ML models, including one or more performance metrics. As can be appreciated, certain metrics for evaluating the performance of ML models 110a-110n—such as precision, recall, or accuracy—can be determined from periodic execution of ML models 110a-110n in the monitoring runs. Generally, the monitoring runs can comprise the retrieval of model input data from database 108a, execution of the ML model 110a-110n on the model input data to generate corresponding output from the model 110a-110n, and evaluation of the output to determine the performance metric(s)—which can be stored in database 108b for subsequent processing. In some embodiments, server computing device 106 can analyze the performance data generated from the monitoring runs against defined performance threshold(s) to identify performance anomaly alerts for the models 110a-110n. The identified alerts can be transmitted to remote computing devices (such as client computing device 102) for actioning, as well as converted into adjustments to hyperparameters associated with monitoring of the ML models 110a-110n and/or the performance thresholds used to evaluate model performance.

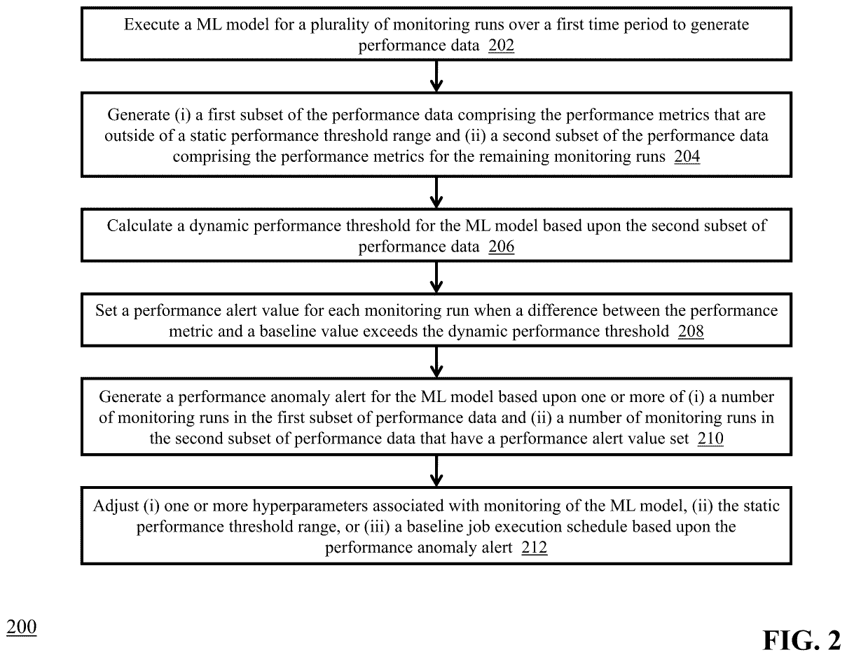

FIG. 2 is a flow diagram of a computerized method 200 of machine learning model performance monitoring and adjustment using dynamic model-based performance criteria, using system 100 of FIG. 1. As mentioned above, model execution module 106a of server computing device 106 executes (step 202) a machine learning model (e.g., models 110-110n) for a plurality of monitoring runs over a first time period to generate performance data associated with the ML model 110a-110n. The performance data comprises, for each of the plurality of monitoring runs, a performance metric associated with execution of the ML model 110a-110n in the corresponding monitoring run. In some embodiments, model execution module 106a stores the performance data generated during the monitoring runs in one or more structured files (e.g., JSON, XML) in database 108b.

In some embodiments, the performance metric is precision, i.e., the ratio of data points that are correctly predicted as positive by the model (‘true positives’) to all of the data points predicted as positive (‘true positives’ plus ‘false positives’). For example, if the model 110a-110n is configured to predict whether a financial transaction is fraudulent, a goal is to identify the number of ‘false positives’ generated by the model (i.e., legitimate transactions that the model erroneously predicts as fraudulent). The production ML models 110a-110n are trained on a specific corpus of training data and then deployed to the production computing environment 110 for execution using live transaction data. The deployed ML models 110a-110n typically do not change once they are deployed. However, the live data that is being used as input to the model 110a-110n can change over time (e.g., the attributes or characteristics associated with financial transactions may evolve or transaction patterns may change). As a result, the live production data may gradually diverge from the training data in ways that have a significant impact on the model metrics. Because the models 110a-110n were not trained on a dataset that has the same or similar types of data characteristics that the live production data now has, the model's performance metrics (e.g., accuracy, precision, recall) decrease. When one or more of the ML model's metrics are below a minimum acceptable value, the model owner may decide to remove the model from production usage (to avoid the generation of false positives that can incur unnecessary investigations and processing resources) and modify, rebuild, and/or retrain the model to improve the performance metrics so that the model can be redeployed.

However, it is important to identify truly anomalous performance behavior of ML models 110a-110n and generate corresponding alerts and corrective actions in a dynamic way. As mentioned above, certain existing ML model monitoring platforms simply generate and issue model performance alerts each time the model's performance metrics change. For example, a model's precision may decrease by 0.001% from one modeling run to the next. These existing platforms would automatically generate an alert for admin review and actioning because the model's performance changed-even though the actual decrease in performance is insignificant.

In addition, the existing ML model monitoring platforms do not sufficiently detect consistent anomalous performance over time. For example, an ML model could exhibit a decrease in performance during five of the last seven monitoring runs, each of which resulted in an alert being generated. Existing monitoring platforms are unable to track and detect such patterns of model performance alerts over time. Finally, existing ML model monitoring platforms do not allow for dynamic assessment and alteration of performance thresholds for ML models based upon the model's performance over time, in order to detect sudden significant changes in model performance.

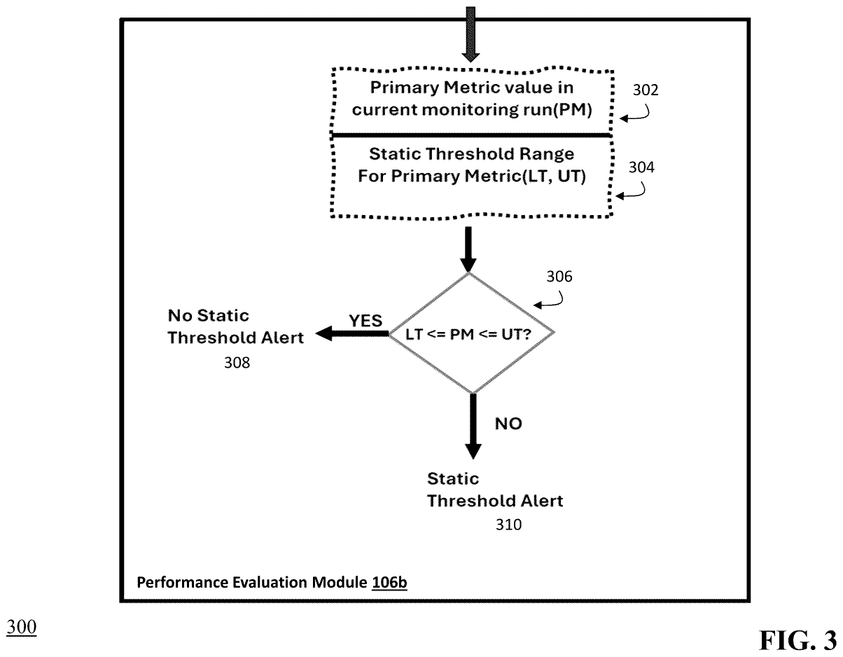

The methods and systems described herein overcome the above-described technical deficiencies of existing ML model monitoring platforms. Performance evaluation module 106b of server computing device 106 generates (step 204) two subsets of data from the performance data generated via the monitoring runs: (i) a first subset of the performance data comprising the performance metrics that are outside of a static performance threshold range and (ii) a second subset of the performance data comprising the performance metrics for the remaining monitoring runs. In some embodiments, each ML model 110a-110n is assigned a static performance threshold range that comprises a lower bound (LT) and an upper bound (UT). The LT value corresponds to a minimum acceptable value for the performance metric being captured during the monitoring runs. The UT value corresponds to a maximum acceptable value for the performance metric being captured during the monitoring run. FIG. 3 is a flow diagram of an exemplary computerized method 300 for detecting a performance alert based upon performance data outside of the static threshold range, as executed by performance evaluation module 106b. As shown in FIG. 3, module 106b receives the primary performance metric value (PM) 302 generated from one of the plurality of monitoring runs for the specific ML model 110a-110n that was executed. The module 106b is also configured to store the static threshold range (LT, UT) 304 for the primary performance metric for ML model 110a-110n.

Performance evaluation module 106b compares (306) the primary performance metric value (PM) to the static threshold range (LT, UT) as follows:

LT≤PM≤UT

When the primary performance metric value falls within the static threshold range, module 106b does not assign (308) a static threshold alert to the monitoring run. When the primary performance metric value falls outside of the static threshold range, module 106b assigns (310) a static threshold alert to the monitoring run. In some embodiments, assigning a static threshold alert to the monitoring run comprises setting a static alert flag value in a data record corresponding to the specific monitoring run for the ML model being evaluated. For example, a static alert flag value of 1 indicates that the primary performance metric value falls outside the static threshold range, while a static alert flag value of 0 indicates that the primary performance metric value falls within the static threshold range.

Turning back to FIG. 2, performance evaluation module 106b calculates (step 206) a dynamic performance threshold for the ML model 110a-110n being evaluated based upon the second subset of performance data. As described previously, the second subset of performance data comprises the performance metric(s) associated with monitoring runs for the ML model 110a-110n that did not trigger the generation of a static threshold alert in step 204. In some embodiments, model execution module 106a or performance evaluation module 106b includes a ‘baseline’ monitoring run data record in the performance data for the plurality of monitoring runs. The baseline monitoring run comprises a baseline value for the performance metric being analyzed, which then can be used to calculate a dynamic threshold for the performance metric. In some embodiments, the baseline value is determined by the model owner after reviewing the model's baseline performance. In some embodiments, the baseline value is determined at least in part based upon the static threshold range associated with the performance metric for the ML model 110a-110n. As one example, if the static threshold range is 75 to 95, the baseline value can be set to the midpoint of the range, i.e., 85. Performance evaluation module 106b can include the baseline monitoring run in the second set of performance data for calculating the dynamic threshold, as will be described below.

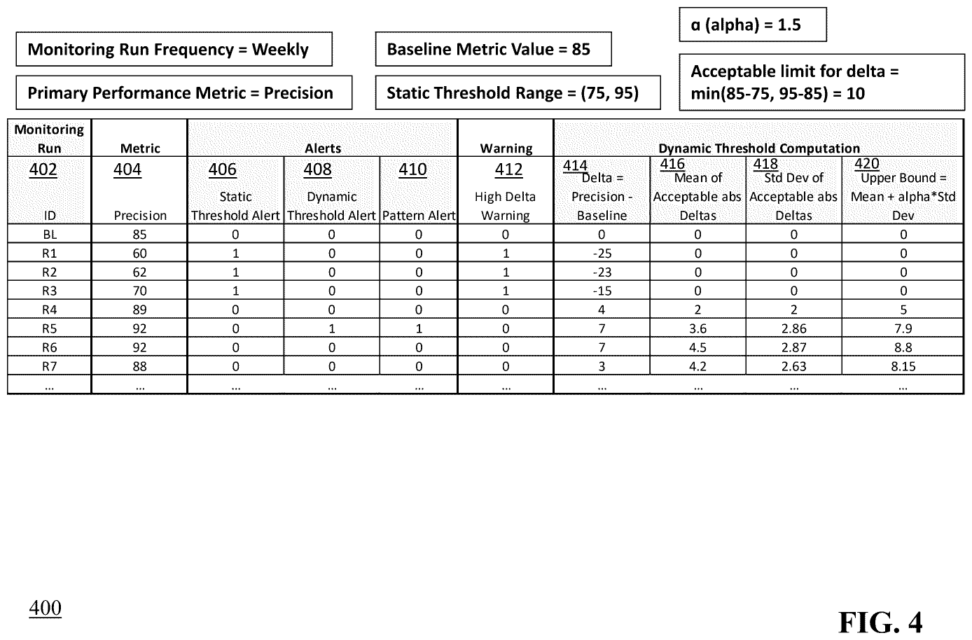

FIG. 4 is a diagram of a table 400 of performance data, threshold data, and alert data for a plurality of monitoring runs of an ML model 110a-110n. As shown in FIG. 4, the table 400 includes an identifier for each monitoring run (column 402), the performance metric captured for the monitoring run (column 404) (in this example, precision), alert values for the monitoring run (static threshold alert in column 406, dynamic threshold alert in column 408, and pattern alert in column 410), high delta (D) warning value for the monitoring run (column 412), and dynamic threshold computation values for the monitoring run (delta in column 414, mean of acceptable absolute value (abs) of deltas in column 416, standard deviation (std_dev) of acceptable abs deltas in column 418, and upper bound (mean+alpha*std_dev) in column 420). Monitoring run BL corresponds to the baseline monitoring run as described above. Monitoring runs R1 to R7 comprise the data associated with the plurality of monitoring runs executed by module 106a using one of the ML models 110a-110n. For example, the precision value in column 404 corresponds to the precision determined from execution of the ML model 110a-110n in the associated monitoring run. Columns 414 to 420 comprise the data elements used by performance evaluation module 106b to calculate the dynamic threshold value for the ML model's performance. Specifically, column 414 comprises the delta value for the monitoring run, which is the difference between the generated performance metric and the baseline value. For example, in monitoring run R1 the precision value was 60. When compared to the baseline value of 85, the resulting delta value for R1 is (85−60), or −25. Column 416 comprises the mean of acceptable absolute value deltas. Because the performance metrics for monitoring runs R1, R2 and R3 fall outside the static threshold range, those delta values are not ‘acceptable’ and thus are not used in calculating the dynamic threshold. In contrast, monitoring run R4 has a precision of 89, which results in a delta value of 4. Therefore, the delta value for R4 is acceptable. Column 418 comprises the standard deviation of the acceptable absolute value deltas. Column 420 comprises the upper bound (UB) dynamic threshold value based upon the monitoring run. The UB value is calculated as follows:

UB=mean+(α*std dev)

where mean is the mean of acceptable absolute value deltas, a (alpha) is a constant value (described in detail below), and std dev is the standard deviation of acceptable absolute value deltas. As shown in FIG. 4, the upper bound (UB) (column 420) for the baseline run is initialized with a value of 0.

As can be appreciated, to sufficiently understand a model's performance prior to generating any alerts, it is optimal to aggregate performance data from an initial batch of monitoring runs during a first period of time (i.e., the observation window) so that model behavior can be estimated. In some embodiments, the size (number of runs) of the initial observation window can be based upon how frequently the monitoring runs are executed. As an example, if a monitoring run is performed daily, the initial observation window size can be set to 30 runs. If a monitoring run is performed weekly, the initial observation window size can be set to 5 runs. And, if a monitoring run is performed monthly, the initial observation window size can be set to 3 runs. In the example of FIG. 4, because the monitoring run frequency is set to weekly, monitoring runs BL and R1 to R4 comprise the initial observation window for the ML model performance. Performance evaluation module 106b uses performance data from at least a portion of the monitoring runs in the initial observation window to calculate (step 206) the dynamic performance threshold for the ML model.

As shown in FIG. 4, monitoring runs R1, R2, and R3 each have a precision value 404 that falls outside of the static threshold range of (75, 95). Performance evaluation module 106b assigns each of those monitoring runs a static threshold alert value of 1 (column 406)—as described above with respect to FIG. 3. Module 106b then captures the performance data for monitoring runs BL and R4 to be used in calculating the dynamic threshold.

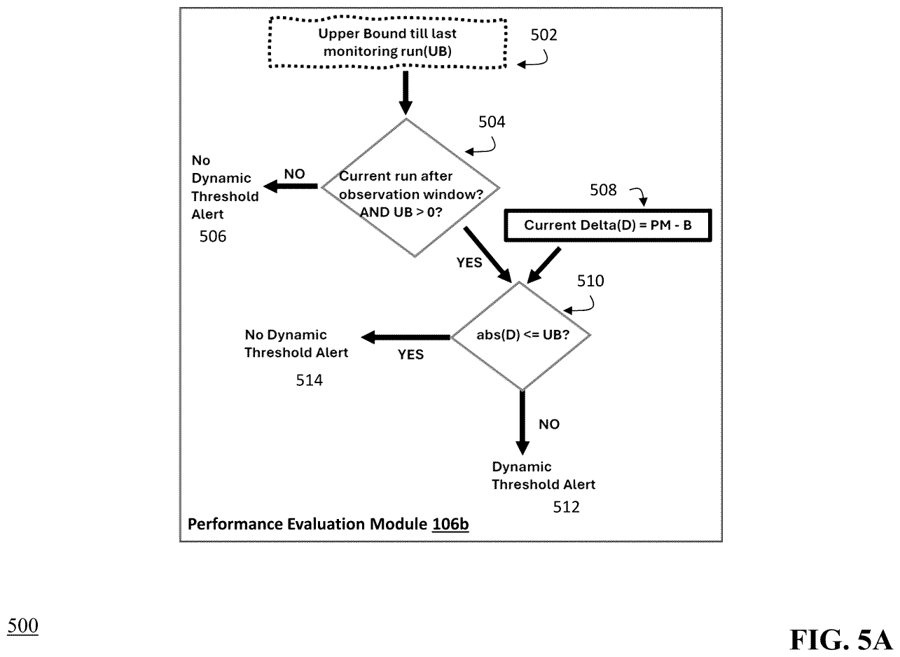

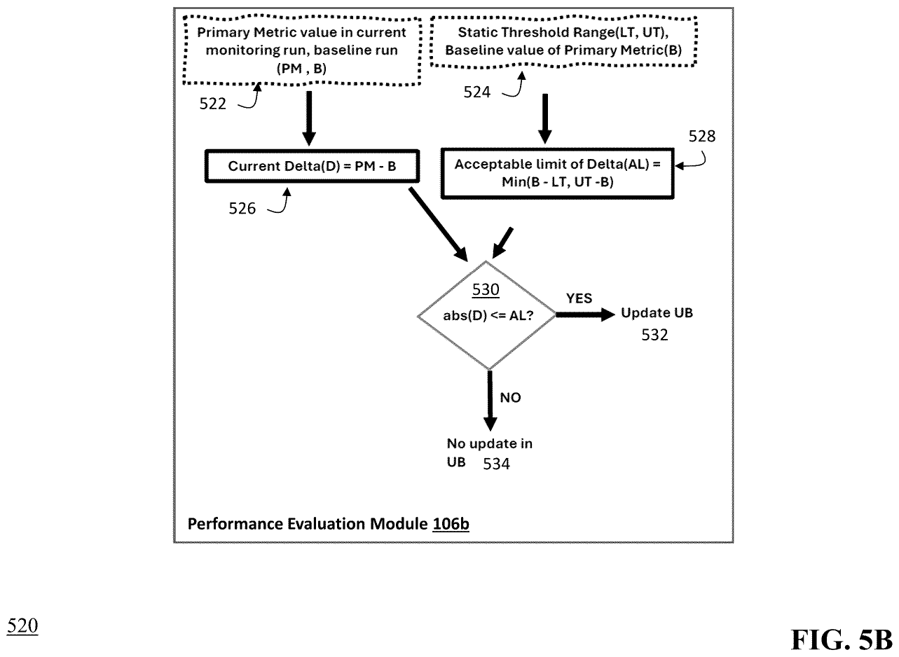

FIG. 5A is a flow diagram of an exemplary computerized method 500 for detecting a dynamic threshold alert, as executed by performance evaluation module 106b. FIG. 5B is a flow diagram of an exemplary computerized method 520 for calculating a dynamic threshold upper bound (UB) value, as executed by module 106b.

In FIG. 5A, performance evaluation module 106b is configured to store the upper bound (UB) (502) calculated from the prior monitoring run. In the example data of FIG. 4, when calculating UB for monitoring run R4, the stored UB (502) is 0, which is from the baseline run BL (as runs R1, R2, and R3 are not being used due to their large delta values). Also, as shown in FIG. 4, the mean value (column 416) for monitoring run R4 is the mean of the delta values for runs BL and R4, or mean(|0|, |4|)=2. The standard deviation value (column 418) for monitoring run R4 is the population standard deviation of the delta values for runs BL and R4, or std_dev(|0|, |4|)=2. The α value is set to 1.5. The UB (column 420) for monitoring run R4 is calculated as:

UB=mean+(α*std dev)

UB=2+(1.5*2)

UB=5

Module 106b determines (504) whether the current monitoring run (i.e., run R4) is after the initial observation window. Because run R4 is part of the initial observation window, module 106b does not set (506) a dynamic threshold alert (column 408 of FIG. 4) for run R4.

Turning to FIG. 5B, performance evaluation module 106b determines whether the UB value to be used as the dynamic threshold for the next monitoring run (R5) should be updated to match the UB value calculated for run R4. As noted above, the UB for run R4 is 5. At step 522, module 106b captures the primary performance metric value (PM) for the current monitoring run R4 (i.e., 89) and the primary performance metric value (B) for the baseline run BL (i.e., 85). At step 524, module 106b captures the static threshold range (LT=75, UT=95).

At step 526, performance evaluation module 106b determines the delta (D) for the current monitoring run R4, as follows:

Current delta(D)=PM−B

D=89−85

D=4

At step 528, module 106b determines an acceptable limit of the delta value (AL) using the static threshold range, as follows:

AL=min(B−LT,UT−B)

AL=min(85−75,95−85)

AL=min(10,10)

AL=10

At step 530, performance evaluation module 106b then determines whether the absolute value of D is less than or equal to AL. If so, module 106b updates (532) the UB dynamic threshold value to correspond to the UB value for the current monitoring run (which, for run R4, equals 5). If not, module 106b does not update (534) the UB dynamic threshold value.

Performance evaluation module 106b continues to the next monitoring run R5 and repeats the processing described herein with respect to FIGS. 3, 5A, and 5B, with the corresponding values shown in FIG. 4.

Turning to FIG. 4, the performance metric (PM) for monitoring run R5 is determined as 92. Because this metric value is within the static threshold range of 75 to 95, module 106b does not flag the monitoring run with a static threshold alert (see FIG. 3). Module 106b calculates the delta (D) for monitoring run R5 as (PM−B), or (92−85)=7. Next, module 106b determines the mean of acceptable absolute value deltas for monitoring run R5 as the mean of deltas for runs BL, R4 and R5, or mean(7, 4, 0)=3.6. Module 106b then determines the standard deviation of acceptable absolute value deltas for run R5 as the population standard deviation of deltas for runs BL, R4, and R5, or std_dev(7, 4, 0)=2.86.

Turning back to FIG. 2, performance evaluation module 106b can set (step 208) a performance alert value for monitoring run R5 by determining whether a difference between the performance metric (PM) and the baseline value (B) exceeds the dynamic performance threshold (UB) that was calculated for the previous monitoring run R4 (see FIG. 5A). Following the processing steps in FIG. 5A, the UB from the last monitoring run R4 (i.e., 5) is captured (502) by module 106b. The module 106b then determines (504) that the current run R5 is after the initial observation window and the UB from run R4 is greater than 0. Module 106b captures (508) the current delta (D) for monitoring run R5 (i.e., 7). Then, module 106b determines (510) whether the absolute value of D is less than or equal to UB. In this example, the absolute value of D is greater than the value of UB, i.e., 7>5. As a result, module 106b flags (512) monitoring run R5 with a dynamic threshold alert (see column 408 of FIG. 4). In a scenario where the absolute value of D is less than or equal to UB, module 106b does not flag (514) the monitoring run with a dynamic threshold alert.

Module 106b then calculates the UB dynamic threshold value for monitoring run R5 as:

UB=mean+(α*std dev)

UB=3.6+(1.5*2.86)

UB=7.90

Then, following the steps of FIG. 5B, performance evaluation module 106b determines whether to update the UB value to be used for determining a dynamic threshold alert for the next monitoring run (R6). As shown in FIG. 4, the data record for monitoring run R5 includes the above-determined values for delta, mean, std dev, and UB.

As can be appreciated, performance evaluation module 106b can repeat the processing described above for the performance metrics corresponding to each of a plurality of monitoring runs for a defined time period-which can generate static or dynamic threshold alerts for at least a portion of the monitoring runs. Module 106b can store the data elements generated by the processing in performance data database 108b.

Turning back to FIG. 2, alert computation module 106c of server computing device 106 can analyze the performance metrics and related alerting data to generate (step 210) a performance anomaly alert for the ML model 110a-110b based upon one or more of: (i) a number of monitoring runs in the first subset of performance data and (ii) a number of monitoring runs in the second subset of performance data that have a performance alert value set. As described previously, the first subset of performance data comprises monitoring runs for which a static threshold alert was set (i.e., monitoring runs with a performance metric that falls outside of the static threshold range). The second subset of performance data comprises monitoring runs for which a static threshold alert was not set, but at least a portion of these monitoring runs may have set a dynamic threshold alert. Module 106c can analyze the alert values for a plurality of monitoring runs of a given model 110a-110n to identify pattern(s) of static or dynamic alerts that indicate a performance anomaly for the model.

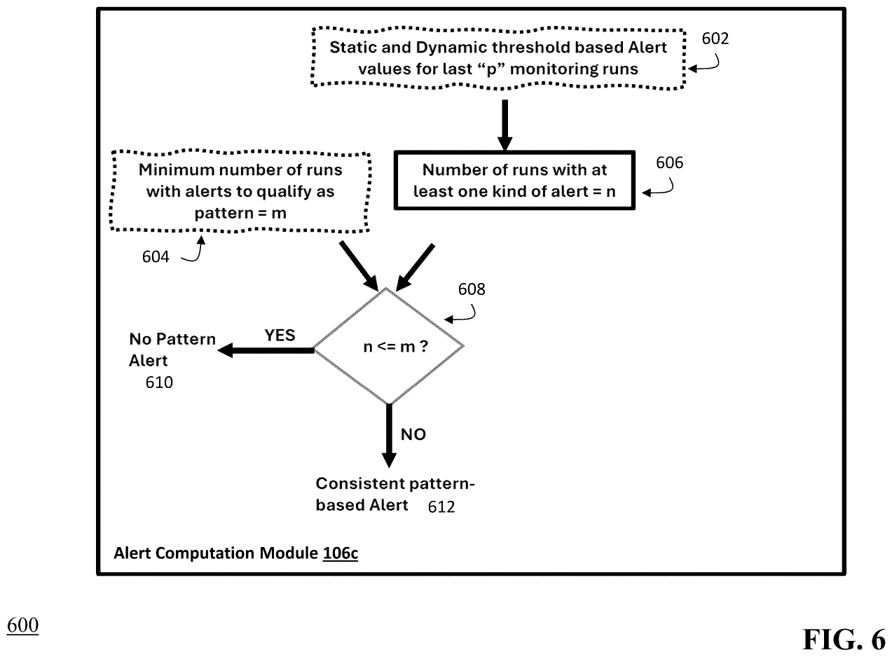

FIG. 6 is a diagram of an exemplary computerized method of generating a performance anomaly alert for an ML model, as executed by alert computation module 106c. As shown in FIG. 6, module 106c captures (602) the static threshold alert values (column 406 of FIG. 4) and the dynamic threshold alert values (column 408 of FIG. 4) for a plurality of monitoring runs (p) in a defined pattern detection window. In some embodiments, p is determined based upon the number of monitoring runs performed for a given ML model 110a-110n in a defined time period. For example, p may be determined based upon the number of monitoring runs for a model in a year. It should be appreciated that monitoring runs occurring in the initial observation window can be used to determine the existence of performance anomalies as described herein. Module 106c also is configured to store (604) a parameter (m) that defines the minimum number of monitoring runs with alerts that are needed to qualify as an anomaly (or pattern).

Using the information captured in step 602, alert computation module 106c determines (606) a number of monitoring runs (n) from the pattern detection window that have set at least one of a static threshold alert or a dynamic threshold alert. Module 106c then compares (608) the number of monitoring runs n to the minimum number of runs m to determine whether a consistent pattern of alerts exists in the monitoring run data-when n is less than or equal to m, module 106c determines (610) that no consistent alert pattern exists, and when n is greater than m, module 106c determines (612) that a consistent pattern of alerts exists that should be further analyzed for actioning.

Using the example data 400 provided in FIG. 4 with the method 600 of FIG. 6, alert computation module 106c determines (606) that monitoring runs R1 to R5 are included in the pattern detection window and of these monitoring runs, three have a static threshold alert (R1, R2, R3) and one has a dynamic threshold alert (R5). Therefore, the number of runs (n) with at least one kind of alert is 4. Module 106c then compares (608) this number with the minimum number (m). In some embodiments, m is determined based upon the pattern detection window size. For example, m can be at least 60-75% of the window size. For the purposes of this example, m is stored as 3. Module 106c determines that n is greater than m, so a pattern-based alert should be issued (612).

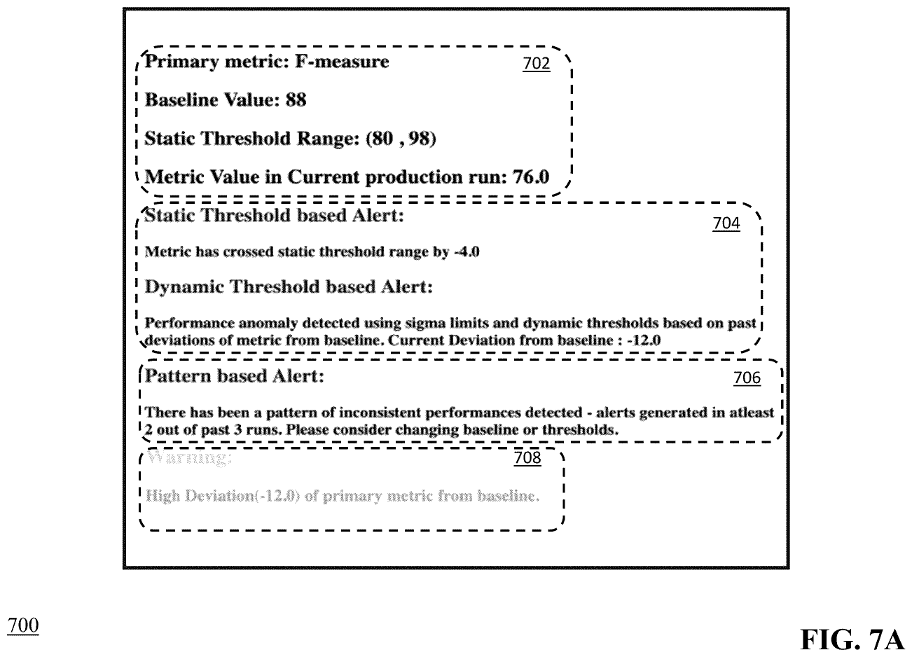

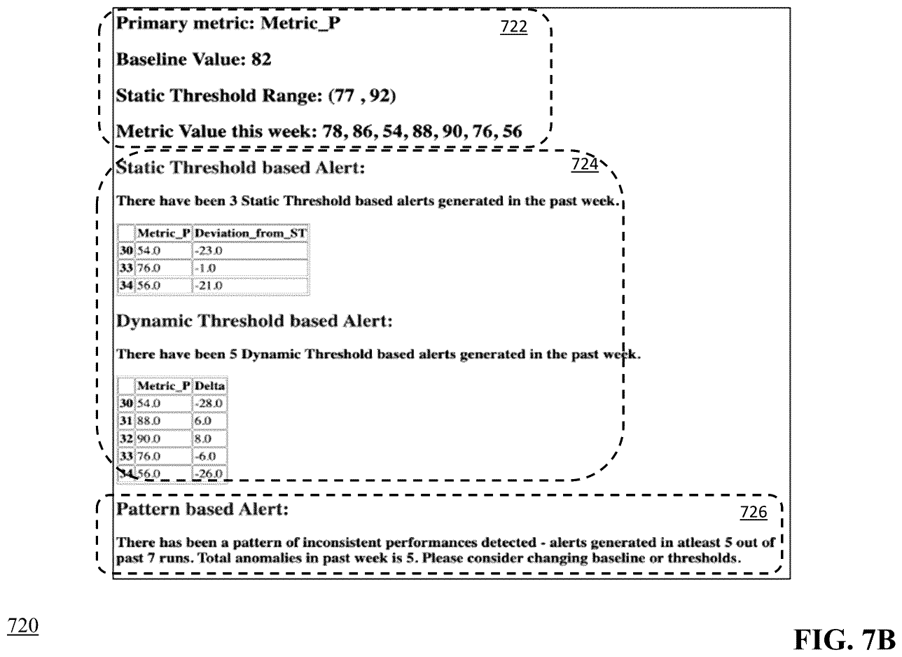

In some embodiments, when alert computation module 106c determines that a consistent pattern-based alert exists for a given ML model 110a-110n, module 106c transmits a signal to user interface (UI) module 106e for generation of a user interface displayed on client computing device 102 that comprises detailed information about the model performance during a specific period of time and the corresponding alerts/anomalies. FIG. 7A is a diagram of an exemplary user interface 700 of an alert summary report for a specific monitoring run. As shown in FIG. 7A, the user interface 700 includes information 702 about the performance metrics (e.g., baseline, static threshold range, current metric) as well as information 704 corresponding to specific static and/or dynamic threshold alerts. In addition, the user interface 700 includes information 706 about any pattern-based alerts generated for the ML model 110a-110n in a certain time period (e.g., past x number of runs) and warning message(s) 708 to highlight performance-related data issues or discrepancies.

FIG. 7B is a diagram of an exemplary user interface 720 of an alert summary report for a plurality of monitoring runs in a given time period (e.g., one week). As shown in FIG. 7B, the user interface 720 includes information 722 about the performance metrics (e.g., baseline, static threshold range, current metric) as well as information 724 corresponding to specific static and/or dynamic threshold alerts. In addition, the user interface 720 includes information 726 about any pattern-based alerts generated for the ML model 110a-110n. In some embodiments, user interface module 106e stores data and metadata associated with generation and display of the alert reports in database 108c.

In some embodiments, UI module 106e can transmit the user interfaces to client computing device 102 for display via, e.g., a web browser. For example, UI module 106e can generate display content (e.g., webpages, application user interfaces) including the performance reports described above that is transmitted to client computing device 102 for presentation to a user (e.g., via a browser, native app, or other software). The user can provide input via the corresponding software that is then transmitted back to UI module 106e for processing—for example, to generate different and/or additional content that displays data to the user.

Another capability of server computing device 106 is to automatically generate actionable feedback based on the model performance and alerting data that can be used for self-learning purposes to adjust specific model-related targets, such as: (i) one or more hyperparameters (e.g., a) associated with monitoring of the ML model 110a-110n, (ii) the static performance threshold range (LT, UT), or (iii) a baseline job execution schedule (e.g., comprising instructions to execute a new baseline performance run). As can be appreciated, the self-learning analysis produces several technical benefits for the overall system 100, including but not limited to: reduction of redundant alerts, making dynamic alerts more sensitive to changes in model behavior, and detecting model baseline/benchmark data that is not representative of the current production data.

In some embodiments, UI module 106e is configured to capture input from a user of client computing device 102 regarding whether the model performance alerts being generated by system 100 are redundant or correct. Model adjustment module 106d can use the input as part of the determination of which specific corrective action should be taken with respect to the ML model 110a-110n. For example, module 106d can determine how many dynamic threshold alerts were generated for a given ML model 110a-110n during a specific time period (O). Module 106d can also determine which of these generated dynamic threshold alerts were marked in the user input as correct (i.e., non-redundant) (F). It should be appreciated that from the user feedback, only redundant alerts (e.g., false positives) can be detected, not false negatives (that is, alerts that are in fact redundant, but the user marked them as correct). Based upon these two values O and F, module 106d can generate and evaluate one or more changes to the hyperparameters associated with monitoring of the ML model 110a-110n and/or the model's static threshold range to, e.g., reduce the number of redundant alerts. In some embodiments, module 106d can determine that a new baseline run of the model should be executed to generate a new baseline performance metric.

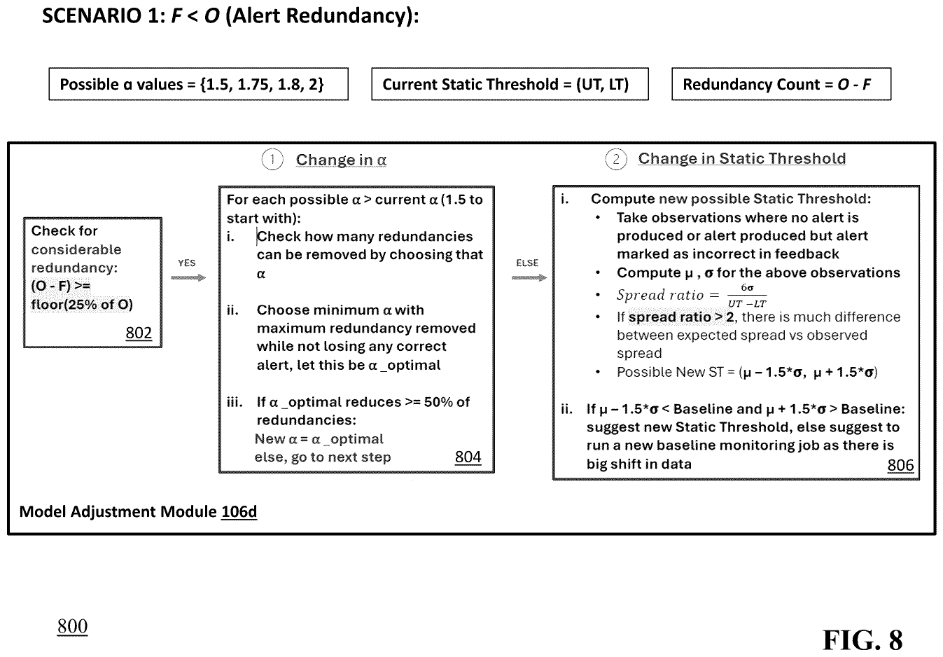

FIG. 8 is a diagram of an exemplary workflow 800 for determining one or more changes to hyperparameters associated with monitoring of the model and/or the model static threshold range values based upon user feedback when there is a difference between the number of alerts generated and the number of alerts marked as non-redundant, as executed by model adjustment module 106d. As shown in FIG. 7, the number of dynamic threshold alerts marked as non-redundant by users (F) is less than the number of dynamic threshold alerts generated (O). As a result, at least some of the dynamic threshold alerts are redundant. Model adjustment module 106d first determines (802) whether there is considerable redundancy, i.e., whether O−F is greater than or equal to a floor value (such as 25% of O). If so, then the count of alerts generated greatly outnumbers the count of non-redundant alerts as identified by user feedback.

Module 106d then evaluates (804) whether a change in the model hyperparameter a (alpha) would result in a reduction of redundancies. In this process, module 106d starts with a set of possible values for α, e.g.: 1.5 (current value), 1.75, 1.8, and 2. For each possible α that is greater than the current α, the module 106d checks how many redundancies would be removed by using that α value in the upper bound (UB) calculations for the dynamic thresholds (see FIG. 4). Based upon those results, module 106d selects the minimum possible α value that has a maximum number of redundant alerts removed while also not erroneously eliminating any correct alerts (α_optimal). Then, module 106d determines whether α_optimal reduces at least 50% of the identified redundancies. If so, then the current model hyperparameter a is replaced with α_optimal for subsequent dynamic threshold alert calculations.

If α_optimal does not reduce at least 50% of the redundancies, model adjustment module 106d determines (806) whether a change to the static threshold range (LT, UT) for the model 110a-110n would reduce the number of redundancies. In this step, module 106d computes a new possible static threshold range by the following process:
Step 1—identify the monitoring runs (i) for which no alert was generated or (ii) for which an alert was generated, but the user feedback indicates that the alert is incorrect;
Step 2—Using the mean(μ (mu)) and standard deviation (σ (sigma)) from the monitoring runs identified in Step 1, calculate:

$$Spread ratio = \frac{6 σ}{UT - LT}$$

If Spread ratio is greater than 2, there is a significant difference between the expected spread and the observed spread. Therefore, calculate a possible new static threshold range as:

Possible new ST=(μ−1.5*σ,μ+1.5*σ)
Step 3—if μ−1.5*σ is less than the baseline metric (B) and μ+1.5*σ is greater than the baseline metric (B), suggest that the model owner replace the current static threshold range with the newly generated static threshold range.

In some embodiments, it should be appreciated that model adjustment module 106d can directly update the current static threshold range with the newly generated static threshold range, without requiring input from the model owner. If the newly generated static threshold range does not meet the above criteria in relation to the baseline metric, model adjustment module 106d instructs user interface module 106e to display a message to a user at client computing device 102 (e.g., as part of a report) that a new baseline monitoring run should be executed for the model 110a-110n because there has been a large shift in data. In some embodiments, model adjustment module 106d is configured to adjust a baseline job execution schedule by, e.g., automatically initiating a new baseline monitoring run for the model 110a-110n and store the resulting new baseline performance metric value in, e.g., database 108b for use as a new baseline monitoring run (BT).

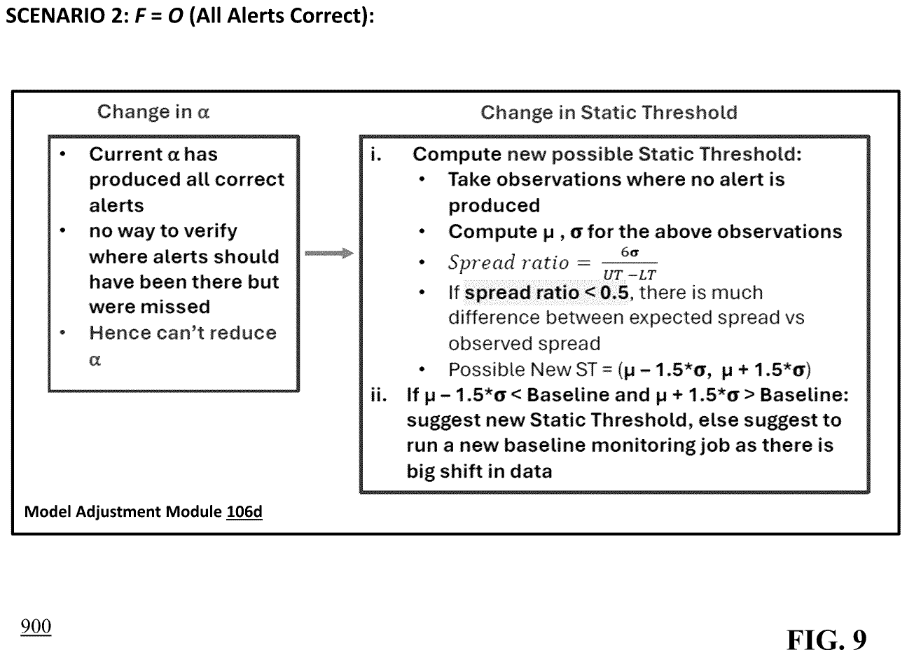

In some cases, the number of dynamic threshold alerts generated by system 100 can match the number of dynamic threshold alerts marked as non-redundant in user feedback (i.e., F=O). For example, the upper bound (UB) used to determine whether to assign a dynamic threshold alert to a monitoring run may have increased too much, meaning that there is less sensitivity to changes in model performance and therefore system 100 produces fewer alerts than are required. In another example, there may be a large data drift in the input data to model 110a-110n, so system 100 produces many alerts but all of these alerts are non-redundant due to the data drift. FIG. 9 is a diagram of an exemplary workflow 900 for determining changes to model static threshold range values based upon user feedback when the number of dynamic threshold alerts generated match the number of dynamic threshold alerts marked as non-redundant, as executed by model adjustment module 106d. As shown in FIG. 9, model adjustment module 106d is unable to make adjustments to the hyperparameter a because the current value for a has produced the correct number of dynamic threshold alerts (according to user feedback). Thus, there is not a way to verify whether any alerts should have been included but were missed and the α hyperparameter cannot be reduced (see 902).

As a result, model adjustment module 106d can only determine (904) whether the static threshold range for the model 110a-110n can be changed to refine the number of dynamic threshold alerts that are generated. In this step, module 106d computes a new possible static threshold range by the following process:
Step 1—identify the monitoring runs for which no alert was generated;
Step 2—Using the mean(μ (mu)) and standard deviation (σ (sigma)) from the monitoring runs identified in Step 1, calculate:

$$Spread ratio = \frac{6 σ}{UT - LT}$$

If Spread ratio is less than 0.5, there is a significant difference between the expected spread and the observed spread. Therefore, calculate a possible new static threshold range as:

Possible new ST=(μ−1.5*σ,μ+1.5*σ).
Step 3—if μ−1.5*σ is less than the baseline metric (B) and μ+1.5*σ is greater than the baseline metric (B), suggest that the model owner replace the current static threshold range with the newly generated static threshold range.

If the newly generated static threshold range does not meet the above criteria in relation to the baseline metric, model adjustment module 106d instructs user interface module 106e to display a message to a user at client computing device 102 (e.g., as part of a report) that a new baseline monitoring run should be executed for the model 110a-110n because there has been a large shift in data. In some embodiments, model adjustment module 106d is configured to adjust a baseline job execution schedule by, e.g., automatically initiating a new baseline monitoring run for the model 110a-110n and store the resulting new baseline performance metric value in, e.g., database 108b for use as a new baseline monitoring run (BT).

Furthermore, in some embodiments, server computing device 106 can generate a recommendation to decommission the ML model 110a-110n from a production computing environment (e.g., environment 110) based upon the determination of model performance as described above. For example, the data from monitoring runs can indicate that the model performance falls outside of an acceptable performance threshold for a certain period of time (e.g., precision is below a minimum acceptable threshold value for at least a period of seven days). In this case, server computing device 106 can generate an alert to one or more remote computing devices (e.g., client device 102) that informs a user of the model's deficient performance metrics and suggests that the model 110a-110n be taken offline (e.g., removed from service in production computing environment) until the model can be reconfigured and/or retrained to improve performance. In some embodiments, server computing device 106 can automatically decommission an underperforming ML model 110a-110n by, e.g., preventing downstream computing devices that invoke the ML model 110a-110n and/or consumers of output from the ML model 110a-110n from accessing the ML model 110a-110n or its output. For example, server computing device 106 can instruct one or more application platforms or network interfaces to block requests for access to model 110a-110n. In another example, server computing device 106 can update a model configuration file in production computing environment 110 to remove indicia associated with the affected ML model 110a-110n. In another example, server computing device 106 can deprecate an API used for sending and receiving messages from model 110a-110n. It should be appreciated that other mechanisms to decommission the ML model 110a-110n from the production computing environment can be envisioned within the scope of the technology described herein.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computer system for machine learning model performance monitoring and adjustment using dynamic model-based performance criteria, the system comprising a server computing device having a memory that stores computer-executable instructions and a processor that executes the computer-executable instructions to:
execute a machine learning model for a plurality of monitoring runs over a first time period to generate performance data comprising, for each of the plurality of monitoring runs, a performance metric associated with execution of the machine learning model for the monitoring run;
generate (i) a first subset of the performance data comprising the performance metrics for each monitoring run in the performance data that are outside of a static performance threshold range for the machine learning model and (ii) a second subset of the performance data comprising the performance metrics for the remaining monitoring runs;
calculate a dynamic performance threshold for the machine learning model based upon the second subset of performance data;
set, for each monitoring run in the second subset of performance data, a performance alert value when a difference between the performance metric for the monitoring run and a baseline value exceeds the dynamic performance threshold for the machine learning model;
generate a performance anomaly alert for the machine learning model based upon one or more of: (i) a number of monitoring runs in the first subset of performance data and (ii) a number of monitoring runs in the second subset of performance data that have a performance alert value set; and
adjust (i) one or more hyperparameters associated with monitoring of the machine learning model, (ii) the static performance threshold range, or (iii) a baseline job execution schedule for the machine learning model, based upon the performance anomaly alert.

2. The system of claim 1, wherein the server computing device retrains the machine learning model based upon the adjustments.

3. The system of claim 2, wherein the server computing device executes the updated machine learning model for a second plurality of monitoring runs over a second time period to generate second performance data comprising, for each of the second plurality of monitoring runs, a second performance metric associated with execution of the machine learning model for the monitoring run.

4. The system of claim 1, wherein the performance metric for each of the plurality of monitoring runs comprises model accuracy, model recall, model precision, or combinations thereof.

5. The system of claim 1, wherein the dynamic performance threshold for the machine learning model is calculated using the formula
dynamic performance threshold=mean(|d|)+α*σ(|d|)
where d is the difference between the performance metrics for each monitoring run in the second subset of performance data and the baseline value and α is a constant value.

6. The system of claim 5, wherein a is in the range of 1.5 to 2.

7. The system of claim 6, wherein adjusting one or more hyperparameters associated with monitoring of the machine learning model comprises updating a used in calculating the dynamic performance threshold.

8. The system of claim 1, wherein the second subset of performance data used to calculate the dynamic performance threshold for the machine learning model is associated with monitoring runs assigned to a defined time window.

9. The system of claim 1, wherein generating a performance anomaly alert for the machine learning model comprises:
detecting a pattern based on the number of monitoring runs in the first subset of performance data and the number of monitoring runs in the second subset of performance data that have a performance alert value set; and
generating the performance anomaly alert for the machine learning model based on the detected pattern.

10. The system of claim 9, wherein generating a performance anomaly alert for the machine learning model comprises removing one or more redundancies in the monitoring runs in the second subset of performance data that have a performance alert value set.

11. The system of claim 1, wherein the performance anomaly alert is transmitted to a remote computing device for display to a user and receipt of feedback from the user.

12. The system of claim 1, wherein the server computing device provides a decommissioning recommendation for the machine learning model from a production computing environment based upon the performance anomaly alert.

13. A computerized method of machine learning model performance monitoring and adjustment using dynamic model-based performance criteria, the method comprising:
executing, by a server computing device, a machine learning model for a plurality of monitoring runs over a first time period to generate performance data comprising, for each of the plurality of monitoring runs, a performance metric associated with execution of the machine learning model for the monitoring run;
generating, by the server computing device, (i) a first subset of the performance data comprising the performance metrics for each monitoring run in the performance data that are outside of a static performance threshold range for the machine learning model and (ii) a second subset of the performance data comprising the performance metrics for the remaining monitoring runs;
calculating, by the server computing device, a dynamic performance threshold for the machine learning model based upon the second subset of performance data;
setting, by the server computing device for each monitoring run in the second subset of performance data, a performance alert value when a difference between the performance metric for the monitoring run and a baseline value exceeds the dynamic performance threshold for the machine learning model;
generating, by the server computing device, a performance anomaly alert for the machine learning model based upon one or more of: (i) a number of monitoring runs in the first subset of performance data and (ii) a number of monitoring runs in the second subset of performance data that have a performance alert value set; and
adjusting, by the server computing device, (i) one or more hyperparameters associated with monitoring of the machine learning model, (ii) the static performance threshold range, or (iii) a baseline job execution schedule for the machine learning model, based upon the performance anomaly alert.

14. The method of claim 13, further comprising retraining, by the server computing device, the machine learning model based upon the adjustments.

15. The method of claim 14, further comprising executing, by the server computing device, the updated machine learning model for a second plurality of monitoring runs over a second time period to generate second performance data comprising, for each of the second plurality of monitoring runs, a second performance metric associated with execution of the machine learning model for the monitoring run.

16. The method of claim 13, wherein the performance metric for each of the plurality of monitoring runs comprises model accuracy, model recall, model precision, or combinations thereof.

17. The method of claim 13, wherein the dynamic performance threshold for the machine learning model is calculated using the formula
dynamic performance threshold=mean(|d|)+α*σ(|d|)
where d is the difference between the performance metrics for each monitoring run in the second subset of performance data and the baseline value and α is a constant value.

18. The method of claim 17, wherein a is in the range of 1.5 to 2.

19. The method of claim 18, wherein adjusting one or more hyperparameters associated with monitoring of the machine learning model comprises updating a used in calculating the dynamic performance threshold.

20. The method of claim 13, wherein the second subset of performance data used to calculate the dynamic performance threshold for the machine learning model is associated with monitoring runs assigned to a defined time window.

21. The method of claim 13, wherein generating a performance anomaly alert for the machine learning model comprises:
detecting a pattern based on the number of monitoring runs in the first subset of performance data and the number of monitoring runs in the second subset of performance data that have a performance alert value set; and
generating the performance anomaly alert for the machine learning model based on the detected pattern.

22. The method of claim 21, wherein generating a performance anomaly alert for the machine learning model comprises removing one or more redundancies in the monitoring runs in the second subset of performance data that have a performance alert value set.

23. The method of claim 13, wherein the performance anomaly alert is transmitted to a remote computing device for display to a user and receipt of feedback from the user.

24. The method of claim 13, wherein the server computing device provides a decommissioning recommendation for the machine learning model from a production computing environment based upon the performance anomaly alert.
